(19) United States
(12) Patent Application Publication
(10) Pub. No.: US 2007/0195012 A1
(43) Pub. Date: Aug. 23, 2007

(54) Image display apparatus and method for displaying image

(75) Inventors: Tsutomu Ichikawa, Sakai-shi (JP); Satoshi Yokota, Toyonaka-shi (JP); Dai Shintani, Izumi-shi (JP); Hitoshi Hagimori, Ikoma-gun (JP); Kazuo Mitsuyoshi, Kashiba-shi (JP)

Correspondence Address: SIDLEY AUSTIN LLP, 717 NORTH HARWOOD, SUITE 3400, DALLAS, TX, 75201, US

(73) Assignee: KONICA MINOLTA HOLDINGS INC.

(21) Appl. No.: 11/707,726

(22) Filed: Feb. 16, 2007

(30) Foreign Application Priority Data
Feb. 22, 2006 (JP) 2006-045088
Dec. 22, 2006 (JP) 2006-345545

(51) Int. Cl. G09G 5/00

(52) U.S. Cl. 345/8

(57) ABSTRACT

A see-through type image display apparatus and a method for displaying image are provided. This is an image display apparatus mounted on the head or face of a user wherein the user can see through the apparatus to observe the external world, and includes: a see-through type display section for displaying an image; an audio input section for inputting the sound generated from the sound source of the external world and generating an audio signal; a sound source detection section for detecting the relative direction with reference to the image display apparatus of the sound source, based on the audio signal generated by the audio input section; and an image generation section for generating an image representing the direction of the aforementioned sound source based on the direction of the sound source detected by the sound source detection section and for outputting it to the display section.

This application is based on Japanese Patent Application No. 2006-045088 filed on Feb. 22, 2006, and No. 2006-345545 filed on Dec. 22, 2006, in Japanese Patent Office, the entire content of which is hereby incorporated by reference.

### TECHNICAL FIELD

The present invention relates to an image display apparatus and a method for displaying image, particularly to a head-mounted image display apparatus.

### BACKGROUND

One of the techniques known in the conventional art is a head-mounted image display apparatus, HMD (Head Mount Display) which is removably mounted on the head or face of an observer. In this apparatus, an image obtained from an image display device such as a compact CRT or liquid crystal display device (hereinafter also referred to as “image”) is directly projected onto the eyeball of the observer by an ocular optical system, whereby a virtual image can be observed as if the image were projected in the air in an enlarged form.

The HMD is used over an extensive field as a display apparatus for viewing images of such content as a movie or video, and for remote control operation of industrial equipment and medical equipment.

In the HMD, the image of the video or TV equipment, for example, is projected directly onto the eyeballs of an observer so that the impact of a large-sized screen image can be enjoyed, on the one hand. On the other hand, both the right and left eyeballs of the observer viewing the image with the HMD mounted on the head are covered with part of the HMD of such a structure so that the outer world is completely cut off from the viewer. When such an environment is taken into account, this can be said to be even very dangerous. To solve this problem, the HMD of this structure and to ensure easy observation of the outer world, it is required to provide a so-called see-through function wherein the image is superimposed upon the outer world of the observer. To meet this requirement, efforts have been made to develop the following two types of equipment; one is so-called see-through type equipment wherein the content image and various forms of information to assist operation by an operator are superimposed upon a natural image resulting from the incoming external light through the image display of the HMD. The other is enclosed type equipment wherein the incoming external light is completely blocked to display the photographic image obtained by photographing with an electronic camera or the like and subsequent processing.

One of the enclosed type HMDs disclosed so far includes a function of displaying a processed form of the photographic image of the external world, in addition to the function of displaying a content image and various forms of information supplied to the operator in a form superimposed onto the photographic image taken by an electronic camera or the like. Thus, according to the technique proposed in recent years, an HMD incorporating this function is employed as a hearing aid wherein the sound information sampled from the external world is processed into image information and is displayed.

In one of the techniques disclosed in the field of an enclosed type HMD equipped with an electronic camera and microphone, for example, the acquired sound source information of the external world is reproduced in the form of an image and sound by image identification of an image by edge detection of an image taken by an electronic camera, and by sound recognition based on the audio signal sampled by microphone (e.g., Japanese Laid-Open Patent Application Publication No. 2005-165778).

As described above, in the field of the HMD, various study efforts have been made to develop the technique wherein the sound source information of the external world can be displayed as image information.

In the HMD disclosed in the Japanese Laid-Open Patent Application Publication No. 2005-165778, an object (e.g., human, dog, car) contained in the edge image is identified by image recognition, and is displayed as an edge image after having been processed in the color and symbol preset according to the degree of importance of the object. Sound is reproduced at a tone volume conforming to the position and traveling speed of the sound source (object) detected by sound recognition. Thus, when a user is taking a walk outdoors enjoying the image and sound of an HMD mounted on his or her head, the HMD notifies the user of the object that may hinder walking, in the form of an image and sound, thereby ensuring the safety of the user. Incidentally, when the HMD is used by an aurally handicapped person or is used in an environment where sounds are difficult to hear, sound source information is very important for prediction of an impending danger, and it is important to ensure easy identification. However, the HMD disclosed in the Japanese Laid-Open Patent Application Publication No. 2005-165778 is designed in an enclosed structure. The sound source information is displayed as an edge image and symbol, and therefore, intuitive and direct identification of the object of the sound source is considered to be difficult. Further, the sound inputted from a sound source is added to the content sound inputted from outside the HMD, and is outputted by earphones or the like. This arrangement leads to a failure in clear recognition of the desired form of the original content sound. This problem has been left unsolved. Further, identification of an object requires a process of edge enhancement applied to an image taken by an electronic camera, a process of generating an edge image, a process of object extraction from the generated edge image, a process of image recognition to identify the object having been extracted, and various others forms of processing of this nature. This may involve complicated processing and increased apparatus costs.

### SUMMARY

An object of the present invention is to solve the aforementioned problems and to provide a see-through type image display apparatus and method for displaying image wherein correct identification of the external world and safety of a user can be ensured without complicated apparatus structure or increased apparatus costs, even when used by an aurally handicapped person or in an environment where sounds are difficult to hear. In view of forgoing, one embodiment according to one aspect of the present invention is an image display apparatus which is for being attached to a head or a face, and through which a user is able to see an outside world, the apparatus comprising:

a display section which is see-through and displays an image;

an audio input section for inputting a sound generated by a sound source in the outside world and generating an audio signal;

a sound source detection section for detecting a relative direction of the sound source with respect to the image display apparatus based on the audio signal generated by the audio input section; and

an image generation section for generating an image to indicate a direction of the sound source and displaying the image on the display section.

According to another aspect of the present invention, another embodiment is a method for displaying an image on an image display apparatus which is for being attached on a head or a face, and through which a user is able to see an outside world, the method comprising the steps of:

displaying the image on a see-through display section;

inputting a sound generated by a sound source in the outside world, and generating an audio signal;

detecting a relative direction of the sound source with respect to the image display apparatus based on the audio signal;

generating an image to indicate the direction of the sound source based on the detected direction of the sound source; and

displaying the image on the display section.

According to another aspect of the present invention, another embodiment is an image display apparatus, comprising:

a display section for superimposing and displaying an image in a view field of a user of the image display apparatus;

a detection section for detecting location information of an sound source in a surrounding area of the user; and

a display control section for generating an image to indicate a location of the detected sound source and displaying the image on the display section.

### BRIEF DESCRIPTION OF THE DRAWINGS

FIGS. 1 (a) and 1 (b) are external schematic diagrams showing an example of the HMD as an embodiment of the present invention;

FIGS. 2 (a) and 2 (b) are external schematic diagrams showing another example of the HMD as an embodiment of the present invention;

FIG. 3 is a side elevation view in cross section representing the display unit in the HMD as an embodiment of the present invention;

FIG. 4 is a block diagram representing the electric circuit of the HMD as an embodiment of the present invention;

FIGS. 5 (a) and 5 (b) are schematic diagram showing an example of the layout of microphones in the HMD as an embodiment of the present invention;

FIGS. 6 (a) and 6 (b) are schematic diagram showing another example of the layout of microphones in the HMD as an embodiment of the present invention;

FIGS. 7 (a) through 7 (d) are schematic diagrams representing an example of the sound source display in the HMD as an embodiment of the present invention;

FIG. 8 is a schematic diagram representing another example of the sound source display in the HMD as an embodiment of the present invention;

FIG. 9 is a flowchart showing the flow in the display operation of a sound source in the HMD as an embodiment of the present invention;

FIG. 10 is a flowchart showing the flow in the display operation of a sound source resulting from a change in head position in the HMD as an embodiment of the present invention; and

FIGS. 11 (a) through 11 (d) are schematic diagrams showing an example of display of a sound source resulting from a change in head position in the HMD as an embodiment of the present invention.

### DETAILED DESCRIPTION OF THE PREFERRED EMBODIMENT

The following describes the HMD (Head Mount Display) as a typical embodiment of the image display apparatus in the present invention with reference to drawings:

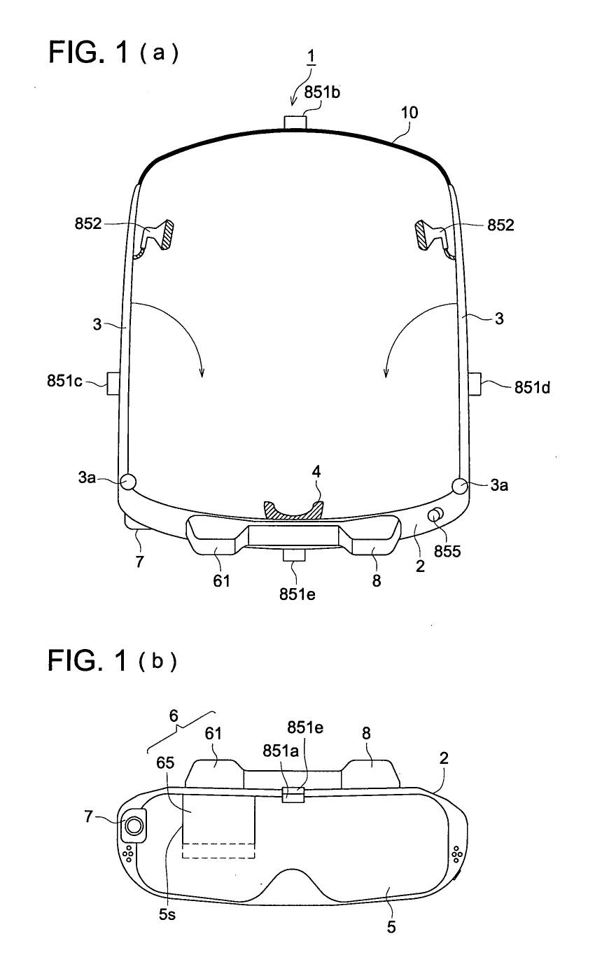

In the first place, the external appearance of the HMD will be described with reference to FIGS. 1 (a) and 1 (b). FIG. 1 (a) is a plan view of the HMD1 of the present invention, and FIG. 1 (b) is a front view.

The HMD1 is a head-mounted image display apparatus mounted und used close to the eyeballs of a user. The major components of the HMD1 include a display unit 6, camera unit 7 and control unit 8. The image captured by the camera unit 7 and the content image of the video or TV sets captured from an external interface 824 (to be described later) mounted on the control unit 8 are displayed on the display unit 6.

The HMD1 is equipped with a frame 2, temple 3 and nose pad 4, as shown in FIG. 1 (a).

A pair of temples 3 are arranged on the right and left of the frame 2. They are long members made of a flexible resilient material. They are applied on the ears and side head of the user, and are employed to hold the HMD1 on the head of the user and to adjust the mounting position. The temples 3 are located at a rotating section 3a rotatably in the direction of the frame 2. When the HMD1 is not used, the temples 3 are rotated toward the frame 2 and are positioned along the transparent substrate 5 (to be described later), whereby the HMD1 is kept compact. The temples 3 are provided with the earphones 852.

Further, as shown in FIG. 1 (b), the frame 2 is provided with a transparent substrate 5. The transparent substrate 5 is an approximately flat plate transparent member that forms a U-shaped space 5s at a position corresponding to one of the eyeballs. An ocular optical system 65 (to be described later) is fitted in the U-shaped space 5s formed by being surrounded with the transparent substrate 5.

The frame 2 contains a display unit 6 made up of an LCD display section 61 (to be described later) and an ocular optical system 65. The display unit 6 corresponds to the display section of the present invention and is used to display the image captured by a camera unit 7 (to be described later) and the content image of the video, TV set or others captured from an external interface 824 (to be described later) arranged on the control unit 8. The display unit 6 also displays the image of the sound source information generated by an image generation section 802 in the controller 801 (to be described later).

The frame 2 is also equipped with a camera unit 7. The camera unit 7 includes a lens 710 (to be described later), CCD (charge coupled device) 701 and image processing section 706, and is used to photograph the external world around the user. The subject optical image formed by the lens 710 is subjected to photoelectric conversion by the CCD 701 to generate an image signal. Predetermined image processing is applied to the image signal by an image processing section 706 and others, whereby an image is generated.

The frame 2 is also equipped with a control unit 8. The control unit 8 is made of a microcomputer, and is used to provide administrative control of the display operation of the display unit 6, photographing operation of the camera unit 7, and image signal processing operation.

The microphones 851a through 851e correspond to the audio input section of the present invention and are used to input the sound generated from the sound source of the external world and to generate audio signals. The microphones 851a and 851e are mounted on the frame 2, the microphones 851c and 851d are provided on the right and left temples 3, respectively, and the microphone 851b is arranged on the headband 10. The details of the layout of the microphones 851a through 851e will be described later.

Further, the frame 2 is equipped with an acceleration sensor 855. The acceleration sensor 855 detects the acceleration signal of the vibration at the time of rotation caused by a change in the position of the user's head, and sends the detected signal to the head position change detecting section 806 in a controller 801 (to be described later).

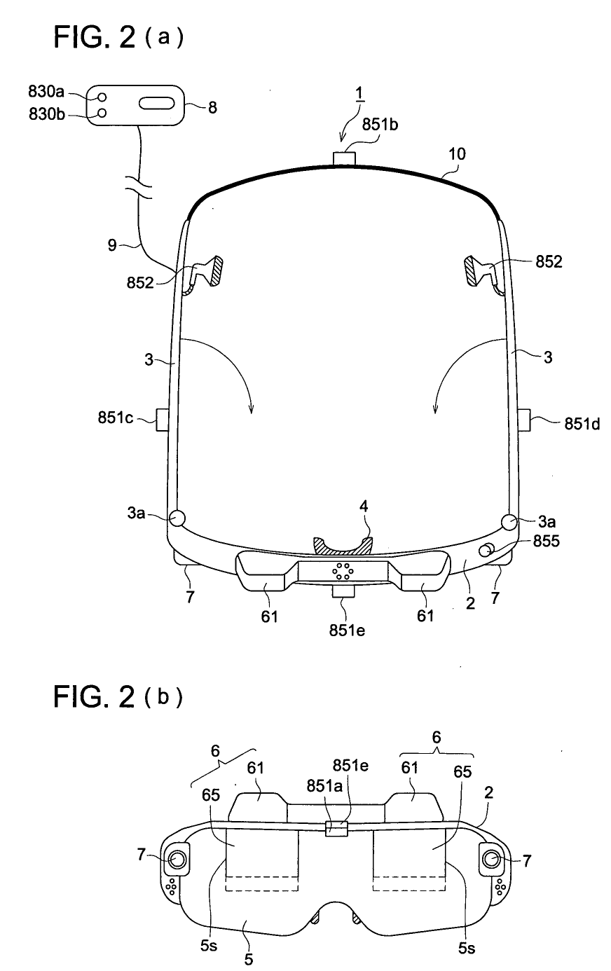

In the structure shown in FIGS. 1 (a) and 1 (b), one camera unit 7 and one display unit 6 are mounted on the left front. As shown in FIG. 2 (a) and FIG. 2 (b), the camera unit 7 and display units 6 can be mounted on each of the right and left of the frame 2 so that the images captured by each camera units 7 are displayed on the corresponding display units 6. In such a structure, the control unit 8 is connected with the display units 6, camera units 7 and others from the rear end of one of the temples 3 through a cable 9, as shown in FIG. 2 (a).

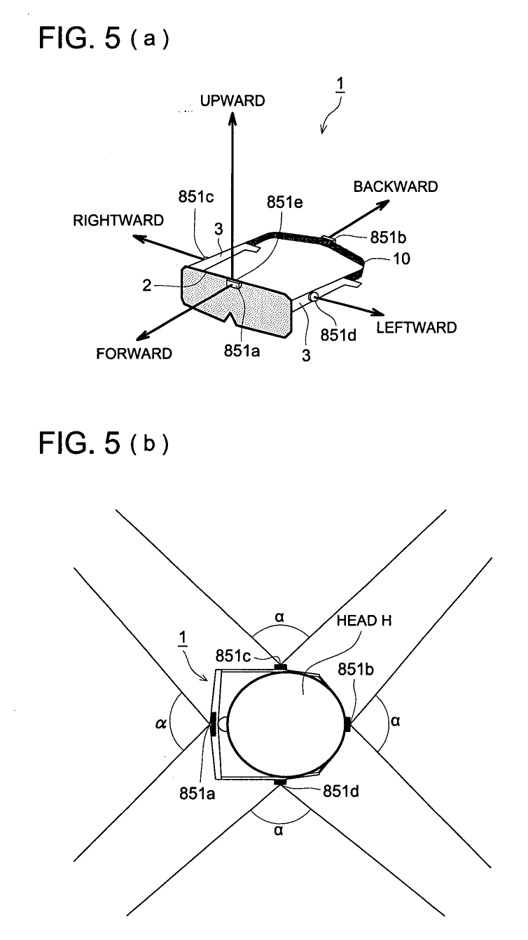

Referring to FIGS. 5 (a) and 5 (b), the following describes the specific layout and directivity of the microphones 851a through 851e. FIG. 5 (a) is a perspective view showing the microphones 851a through 851e of the HMD1. FIG. 5 (b) is a schematic diagram showing the horizontal directivity of the microphones 851a through 851e.

As shown in FIG. 5 (a), the HMD1 has five microphones 851a through 851e. The microphone 851a is mounted at the upper center of the frame 2 so that the sound collecting surface is directed forward. The microphone 851e is laid out at the same position as the microphone 851a so that the sound collecting surface is directed upward. The microphones 851c and 851d are arranged on the temples 3 of the right and left so that the sound collecting surfaces are directed rightward and leftward, respectively. Further, the microphone 851b is arranged on the head band 10 so that the sound collecting surface is directed backward.

Of the five microphones 851a through 851e arranged as mentioned above, the four microphones 851a through 851d directed horizontally can be designed to have such a directivity that the orientation angle α is approximately 90 degrees, for example. Thus, these microphones 851a through 851d are capable of collecting the sound of approximately the entire surrounding area of the external world around the head H of the user in the horizontal direction. Thus, each of the microphones 851a through 851d is laid out around the user's head H so as to be oriented toward the external world. Then, even in the case of a lower directivity of the microphone (where sound over a wider scope is collected), the user's head H serves as a wall and reduces the adverse effect of the sound from opposite the oriented position. Accordingly, the sound source detection section 803 (to be described later) provides high-precision detection of the direction of the sound source.

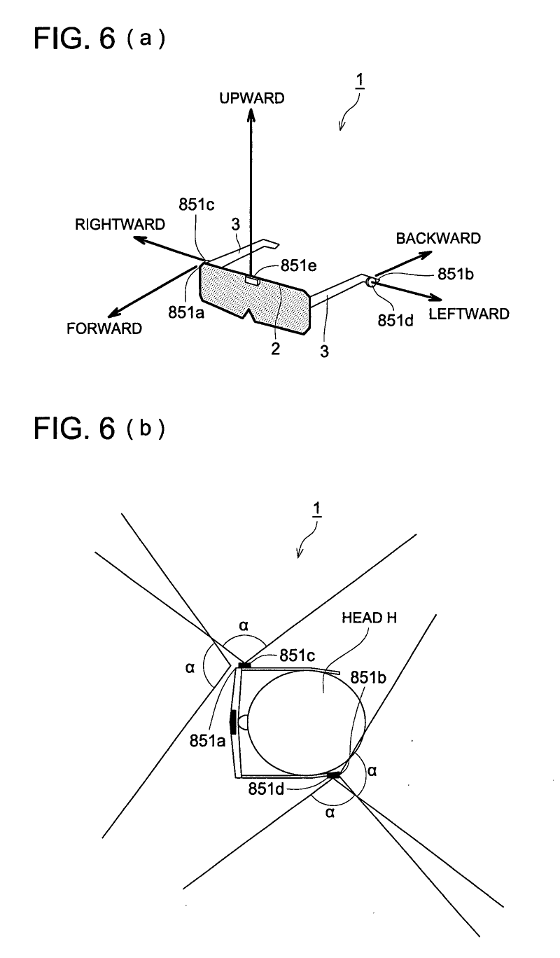

The layout of the microphones 851a through 851e is not restricted thereto. For example, it is possible to use the layout as shown in FIGS. 6 (a) and 6 (b). Namely, the microphones 851a and microphone 851c are arranged on the front end of one of the temples 3 so that the sound collecting surfaces are directed forward and rightward, respectively. The microphones 851b and 851d are arranged on the rear end of the other temple 3 so that the sound collecting surfaces are directed backward and leftward, respectively. The microphone 851e is mounted at the upper center of the frame 2 so that the sound collecting surface is directed upward. If this arrangement is adopted, similarly to the layout described with reference to the aforementioned FIGS. 5 (a) and 5 (b), even in the case of a lower directivity of the microphone (where sound over a wider scope is collected), the user's head H serves as a wall and reduces the adverse effect of the sound from opposite the oriented position. Accordingly, the sound source detection section 803 (to be described later) provides high-precision detection of the direction of the sound source.

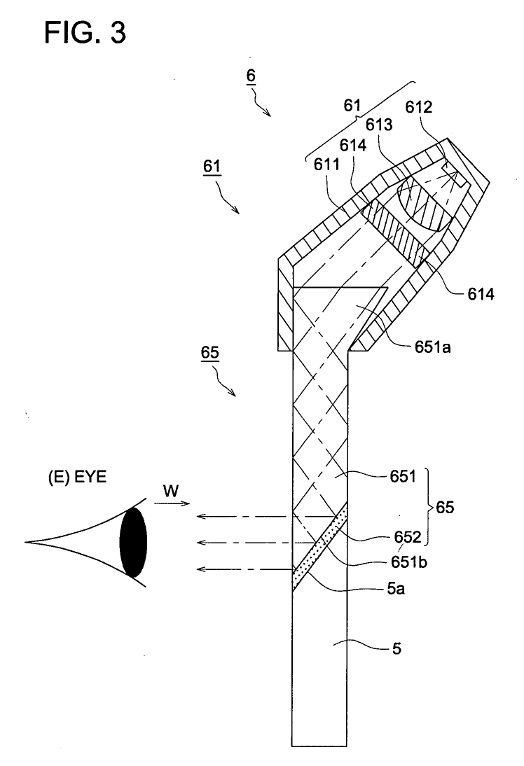

The following describes the structure of the display unit 6 with reference to FIG. 3. FIG. 3 is a side elevation view in cross section as seen the left side surface of the display unit 6 in the HMD1 of the present invention. It mainly shows the internal structure of the display unit 6.

As shown in FIG. 3, the display unit 6 is made up of an LCD display section 61 formed of an enclosure 611, LED (Light Emitting Diode) 612, collimator lens 613, LCD (Liquid Crystal Display) 614; and an ocular optical system 65 formed of a prism 651 and HOE (Holographic Optical Element) 652.

An LED 612, collimator lens 613 and LCD 614 are incorporated in the enclosure 611 of the LCD display section 61. Under this condition, this enclosure 611 is mounted so as to be projected obliquely upward (obliquely to the upper right in FIG. 3) on the top end of the prism 651 of the ocular optical system 65.

The LED 612 is a point light source made up of a light emitting diode (LED) including a predetermined wavelength color.

The collimator lens 613 turns the light of the LED 612 into approximately parallel light, which is projected onto the LCD 614.

The LCD 614 generates an image based on the image signal generated by the camera unit 7; the content image signal, for example, of the video or TV set, captured from the external interface 824 (to be described later) arranged on the control unit 8; and the image signal of the sound source information generated by the image generation section 802 in the controller 801 (to be described later). The LCD 614 constitutes a transparent liquid crystal display panel, for example.

The prism 651 is a transparent member shaped approximately a flat plate made of glass or transparent resin, and is used to reflect the light emitted from the LCD, 614 several times therein. To ensure that the greater portion of the light coming from the LCD 614 can be taken inside, the upper portion of the prism 651 is provided with a wedge-shaped thicker part 651a in such a way that the front side (opposite the ocular surface) is protruded for the purpose of ensuring a greater thickness on the upper portion.

Further, the tilted surface 651b is formed on the lower part of the prism 651. The prism 65 is connected (for example, by bonding) with the tilted surface 5a formed on the transparent substrate 5, through the HOE 652. Further, the front and rear sides of the prism 651 are flush with those of the transparent substrate 5. This arrangement allows the prism 651 to be integrated with the transparent substrate 5 into a single flat plate.

The HOE 652 is made up of a so-called sculptured surface which is axially asymmetric. It is a volume phase type holographic optical device, and is supported on the lower part of the prism 651 at a predetermined tilted angle. When the light led through the prism 651 is applied, the HOE 652 supplies a hologram image to the eyeball E using the phenomenon of light interference.

In the display unit 6 characterized by the aforementioned structure, the light coming from the LED 612 is applied to the LCD 614 through the collimator lens 613, and the image light generated by the LCD 614 by this illumination is fully reflected inside the prism 651 several times. After that, it is diffracted by the HOE 652 and is led to the eyeball E of the user as a virtual image.

Further, the prism 651 leads the forwardly incoming light to the user's eyeball. This arrangement allows the user to see through the external world (forward subject), and to perceive the image (video) captured by the camera unit 7 superimposed on the external world (forward subject).

The tilted surface 5a formed on the transparent substrate 5 cancels (counterbalance) refraction of light by the tilted surface 651b of the prism 651. To be more specific, the prism effect of the tilted surface 651b prevents the light from the side of the arrow mark W from being bent toward the top. This makes it possible for the user to observe the external light through the prism 651, transparent substrate 5 and HOE 652, without the light being distorted.

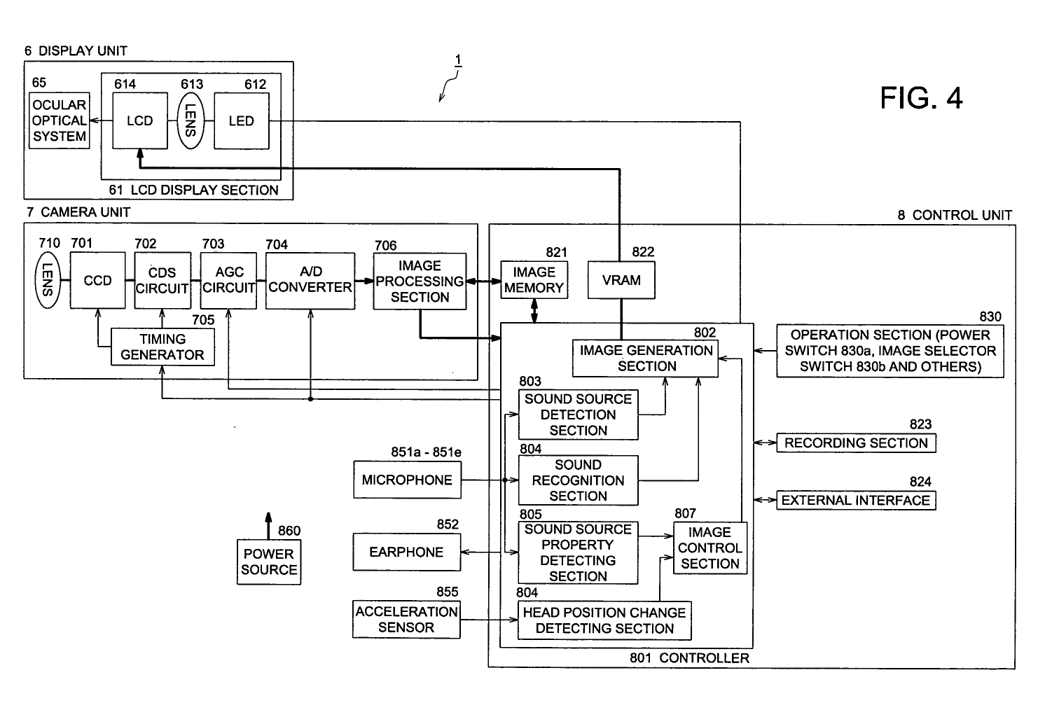

The following describes the electric circuit of the HMD1 with reference to FIG. 4. FIG. 4 is a block diagram showing the electric circuit of the HMD1 of the present invention. In FIG. 4, the same members as those of FIGS. 1 (a) through FIG. 3 are assigned with the same reference numerals.

The major portion of the electric circuit block in the HMD1 is made up of a display unit 6, camera unit 7 and control unit 8.

The display unit 6 is made up of an LCD display section 61 and ocular optical system 65. The operation of each component has already been described and will not be described to avoid duplication.

Drive current of the LED 612 is generated by the controller 801 in a control unit 8 (to be described later), and the brightness of the LED 612 is controlled by the controller 801.

The LCD 614 is used to display an image based on the image signal generated by the camera unit 7 outputted through the control unit 8; the content image signal, for example, of the video or TV set, captured through the external interface 824 (to be described later) arranged on the control unit 8; and the image signal of the sound source information generated by the image generation section 802 in the controller 801 (to be described later).

The camera unit 7 includes a lens 710, CCD 701, CDS circuit 702, AGC circuit 703, A/D converter 704, timing generator 705, and image processing section 706.

The CCD 701, which is a color area sensor containing transparent filters of R (red), G (green) and B (blue) arranged in a checkered pattern in units of pixels, applies a process of photoelectric conversion to the optical image of a subject formed by the lens 710, and converts the image into the image signal (signal composed of a row of pixel signals received in units of pixel) made up of color components of R (red), G (green) and B (blue).

Based on the reference clock sent from the control unit 8 (to be described later), the timing generator 705 generates the drive control signal of the CCD 701. The drive control signal generated by the timing generator 705 is exemplified by the clock signal such as an integration start/stop timing signal for controlling the timing of the start and stop of exposure in the CCD 701, and a signal charge readout control signal for each pixel (e.g., horizontal sync signal, vertical sync signal and transfer signal). When these clock signals are supplied to the CCD 701, drive control is conducted to the CCD 701 in response to each clock signal.

Based on the image signal read out of the CCD 701, the correlated dual sampling (CDS) circuit 702 conducts the reduction of the noise generated at the time of reading and corrects the black level by executing the operation of the OB clamping.

The AGC (Automatic Gain Control) circuit 703 adjusts the gain of the image signal processed by the CDS circuit 702 in conformity to the brightness of the subject, for example, under the control of the control unit 8 (to be described later).

Each pixel signal constituting the image signal inputted from the AGC circuit 703 is converted into the digital signal by the A/D converter 704. Based on the analog-to-digital conversion clock sent from the control unit 8, the A/D converter 704 converts each pixel signal of the analog signal, for example, into the 14-bit digital signal.

As described above, the image signal having been read out by the CCD 701 is subjected to predetermined processing by the CDS circuit 702, AGC circuit 703 and A/D converter 704, and is converted into the digital image signal. The digitized image signal is captured by the image processing section 706 and is subjected to predetermined processing. The following describes the processing applied to the digital image signal by the image processing section 706.

In the first place, synchronously with reading of the image signal outputted from the CCD 701, the digital image signal captured into the image processing section 706 is read into the image memory 821 of the control unit 8 (to be described later). To be more specific, the digital image signal used for processing by the image processing section 706 is first recorded into the image memory 821, and is taken out of the image memory 821. This is used for processing by each section of the image processing section 706.

The image processing section 706 is made up of a black level correcting section, pixel interpolation section, resolution conversion section, white balance controller, gamma correcting section, matrix computing section, shading correcting section and image compressing section (not illustrated) and others. It applies well-known image signal processing to the digital image signal taken out of the image memory 821. The digital image signal having been processed by these components is again stored in the image memory 821.

The control unit 8 includes a controller 801, image memory 821, VRAM (Video Random Access Memory) 822, recording section 823, external interface 824 and operation section 830.

The controller 801 is made up of a ROM (Read On by Memory) for storing each control program, RAM (Random Access Memory) for temporarily storing the data of computation and control processing; and CPU (Central Processing Unit) for reading out the aforementioned control programs from the ROM and executing them. In response to the signal from each operation switch provided on the operation section 830 (to be described later), the controller 801 provides administrative control of the display operation of the display unit 6, photographing operation of the camera unit 7 and image signal processing operation.

As shown in FIG. 4, the controller 801 contains an image generation section 802, sound source detection section 803, sound recognition section 804, sound source property detecting section 805, head position change detecting section 806 and image controller 807.

The sound source detection section 803 corresponds to the sound source detection section and the detection section of the present invention. Using the audio signal inputted and generated by the microphones 851a through 851e, the sound source detection section 803 performs well-known spectral decomposition to find out the spectrum specific to the source of generating a sound, whereby the position of the generating source is estimated.

To put it more specifically, for example, in the audio signals outputted from microphones 851a through 851e, the sounds estimated to be the same (sounds of the same type as exemplified by barking of a dog) are identified by the aforementioned spectral decomposition. Calculation is made to find the intensity of the sound shown by the audio signals outputted from microphones 851a through 851e and the time difference of the aforementioned same sounds in each audio signal. Normally, the intensity of the sound measured at a predetermined position is inversely proportional to the square of the distance from the sound generation source, and the time difference is proportional to the difference of the distance from each microphone to the sound generation source. This principle is utilized to locate the sound generation source. It should be noted that the details of the process of sound source position detection used by the sound source detection section 803 conform to the well-known procedure described in “Head mounted type display apparatus and its control method” disclosed in the Japanese Laid-Open Patent Application Publication No. 2005-165778.

The image generation section 802 corresponds to the image generation section and the display control section of the present invention. Based on the direction and traveling direction of the sound source detected by the sound source detection section 803, the image generation section 802 generates an image showing the direction and traveling direction of the sound source, and this image is displayed on the display unit 6. It should be noted that the details of the image representing the direction and traveling direction of the sound source generated by the image generation section 802 will be described later.

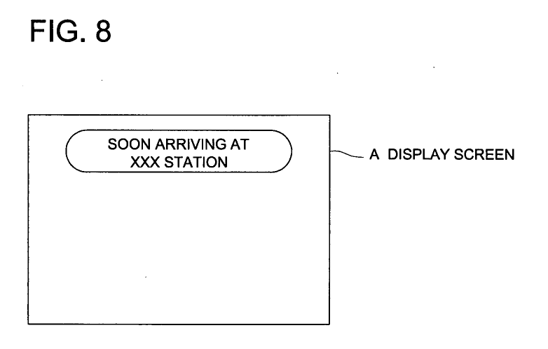

The sound recognition section 804 corresponds to the sound recognition section of the present invention. Using the audio signal inputted and generated by the microphones 851a through 851e, the sound recognition section 804 applies the process of well-known sound recognition, to identify the sound issued from the sound source and converts it into language information. The image generation section 802 can generates a text image, based on the language information obtained from conversion by the sound recognition section 804. To be more specific, the sound information of the external world can be displayed as a text message. Thus, even when the content image and sound are enjoyed, the sound information of the external world can be identified as text information. For example, when a content image or sound is being used in a train, and there is an announcement over the train's loudspeaker which says, “We will be soon arriving at the next station”, then the text message “Soon arriving at XXX station” or the like is displayed, for example, as shown in FIG. 8. This arrangement allows the user to recognize the surrounding situation and to get off the train at the intended station without missing the station. Further, to distinguishing between the announcement over train's loudspeaker and the sound of the nearby people exchanging conversation, the sound from the top of the head is taken as “an announcement over train's loudspeaker”, using the information on the direction of the sound source. Thus, text is displayed only for the announcement over train's loudspeaker. Alternatively, an upward-pointing arrow mark indicating occurrence of “an announcement over train's loudspeaker” is displayed to call attention of the user. If the user is watching a movie in a train using the HMD as an embodiment of the present invention, this arrangement allows the user to view the external sound information in terms of visual data, whereby the user recognizes that the train is coming close to the destination.

Going back to FIG. 4, the sound source property detecting section 805 corresponds to the sound source property detecting section of the present invention. Using the audio signal inputted and generated by the microphones 851a through 851e, the sound source property detecting section 805 detects the properties of the sound source such as sound pressure, frequency, and change rate thereof of the sound coming from the sound source.

When the HMD1 is rotated by a change in the position of the user's head and others, the head position change detecting section 806 detects the rotating direction of the head and the amount of rotation, based on the acceleration signal of the swing detected by the acceleration sensor 855. To be more specific, the acceleration sensor 855 and head position change detecting section 806 serves the function of the movement detection section of the present invention.

The image controller 807 corresponds to the image control section of the present invention, and controls the operation of the image generation section, based on the pressure, frequency and the change rate thereof of the sound produced from the sound source detected by the sound source property detecting section 805 and the rotating direction and amount of rotation of the head detected by the head position change detecting section 806. The details of the control operation of the image generation section 802 carried out by the image controller 807 will be described later.

The image memory 821 is a temporary memory used as a working area for applying various forms of processing to the image signal by the image processing section 706 in the camera unit 7 and the controller 801 in the control unit 8.

The VRAM 822 has a capacity to record the image signal conforming to the number of pixels of the LCD 614 in the LCD display section 61. It is a buffer memory of the pixel signal constituting the image to be reproduced and displayed on the LCD 614.

The recording section 823 is loaded, for example, with a memory card. It is a memory for recording an image captured by the camera unit 7.

The external interface 824 is an interface for inputting image signals from the external device (not illustrated) of the HMD1 such as an video, TV set, personal computer or the like. A movie and music live image recorded on the DVD can be enjoyed when this interface is connected with the HMD1 and mobile DVD reproducing apparatus or the like, using a connection cable through an external interface 824.

The operation section 830 is provided with a power switch 830a, image selector switch 830b and various operation switch of the HMD1. The image selector switch 830b corresponds to the image selection section of the present invention, and selects the image generated by the image generation section 802. To be more specific, the image selector switch 830b can select which of the following images should be generated and displayed by the image generation section 802; an image indicating the direction of the sound source, an image representing the traveling direction of the sound source, and an image representing the direction of the sound source and traveling direction of the sound source. The information on the sound source indicates an alarm to the user. It is important that what is meant by display can be intuitively and directly understood. There are various forms of images that are generated by the image generation section 803. For example, in the image for simultaneous representation of both the direction of the sound source and traveling direction, there may be too much information and the meaning of the display cannot be correctly grasped, depending on the case. Thus, when an image can be selected in response to the user's special conditions or ambient conditions, the correct meaning of the display is directly grasped.

In the HMD1 of such a structure, the present embodiment displays information on the sound source of the external world as image information in order to ensure correct identification of the external world and the safety of the user even when used by an aurally handicapped person or in an environment where sounds are difficult to hear.

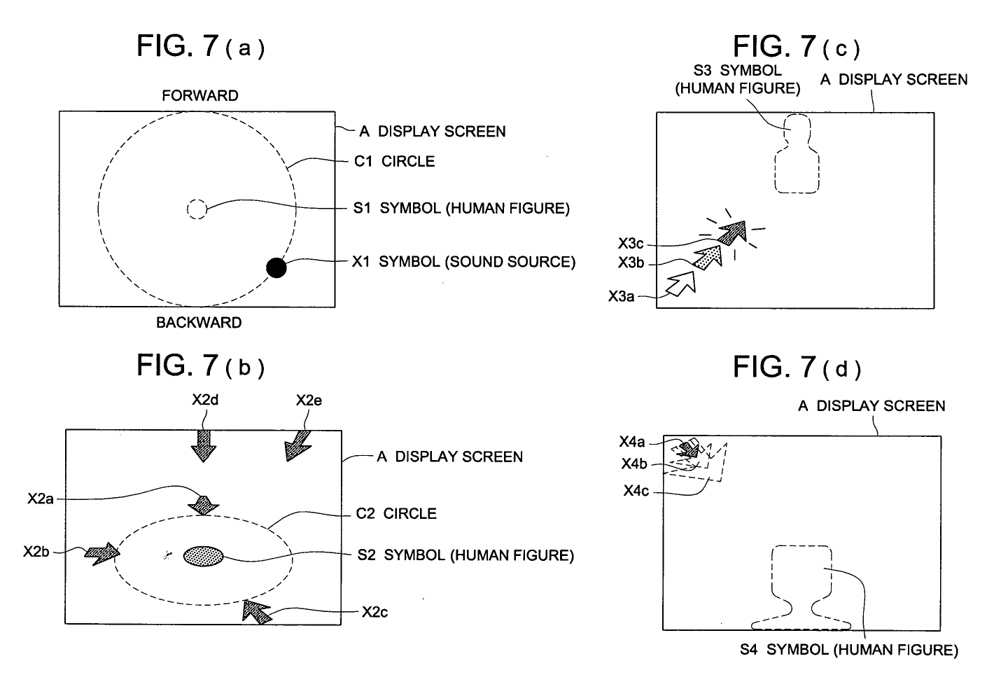

The following describes an example of the display of the image generated by the image generation section 802 with reference to FIGS. 7 (a) through 7 (d). FIG. 7 (a) is a schematic diagram showing an example of the image representing the direction of the sound source. FIG. 7 (b) is a schematic diagram showing another example of the image representing the direction of the sound source. FIG. 7 (c) is a schematic diagram showing an example of the image representing the traveling direction of the sound source. FIG. 7 (d) is a schematic diagram showing another example of the image representing the traveling direction of the sound source.

In the first place, an example of the image representing the direction of the sound source will be explained with reference to FIG. 7 (a). The example of this display shows the position of the sound source when viewed from the top centered on the user. At the center of the display screen A, the symbol S1 representing the user of the HMD1 is indicated by a white circle. Further, in the horizontal direction centered on the symbol S1, the circle C1 showing the direction centered on the user is shown by a circle. Such a plan view centered on the user is shown using a symbol. In this case, the upper portion of the display screen A is assumed as the front side of the user, and the lower portion is as the rear side. For example, when the sound source is located right back of the user, the symbol X1 denoting the sound source is indicated by a black dot at the right bottom on the circular arc of a circle C1. As described above, use of a simple display screen using a symbol allows the user to achieve quick and intuitive grasping of the direction of the sound source.

The following describes another example of the image showing the direction of the sound source with reference to FIG. 7 (b). This example of display indicates the position of the source as viewed obliquely from the top of the rear centering on the user. Close to the bottom of the center of the display screen A, a symbol S2 denoting the user of the HMD1 is shown by a black dot. An ellipse is used to show a circle C2 denoting the direction around the user in the horizontal direction centering on the symbol S2. In this manner, a perspective view as seen obliquely from the top on the rear centering on the user is displayed using a symbol. For example, when the sound source is located on the forward, left and rearward right in the horizontal direction of the user, each of the symbols X2a, X2b and X2c representing the sound sources is shown by an arrow mark in contact with the circle C2. When the sound source is located above the user and obliquely on the right top, each of the symbols X2d and X2e representing the sound sources is shown by an arrow mark so that it will come out of the top center or top right of the screen. Forming a three-dimensional display screen in this manner assists the user to achieve quick and intuitive grasping of the direction of the sound source positioned not only in the horizontal direction but also in the vertical direction. To ensure that the natural image (see-through image) due to the external light observable through the display screen A can observed clearly without being affected by the display of the symbol, each symbol should be indicated by a broken line or in a subtle color.

The following describes an example of the image showing the traveling direction of the sound source with reference to FIG. 7 (c). In this example of display, the symbol for a user is indicated by a human figure, and the traveling direction of the sound source is shown by an arrow mark changed variously. For example, when the sound source comes close to the user from the left rear, the symbol S3 indicating the user of the HMD1 is shown at the top center of the display screen A. In this case, the symbol S3 indicates the user's appearance from the back. The symbols X3a, X3b and X3c representing the sound source are arranged from the bottom left corner of the display screen A to the user, and are indicated by arrow marks. Further, as the sound source comes closer to the user, the density and color of the arrow marks for symbols X3a, X3b and X3c are indicated differently in an easy-to-read color such as red or yellow to give clear warning.

The following describes another example of the image showing the traveling direction of the sound source with reference to FIG. 7 (d). In this example of display, the symbol for a user is indicated by a human figure, and the traveling direction of the sound source is shown by an arrow mark changed variously. For example, when the sound source comes close to the user from the left front, the symbol S4 indicating the user of the HMD1 is shown at the bottom center of the display screen A. In this case, the symbol S4 indicates the user's appearance from the back. The symbols representing the sound source are shown by a blinking arrow mark from the top left corner of the display screen A to the user. Further, as the sound source comes closer to the user, the sizes of the symbols X4a, X4b and X4c are gradually increased in that order and are indicated by blinking at the same position.

The image generation section 802 is capable of generating an image shaped like an image shown in FIG. 7 (a) through FIG. 7 (b), for example. Which form of the image should be generated depends on the direction of the sound source and the traveling direction detected by the sound source detection section 803. For example, when the sound source is located in the horizontal direction of the user, this section generates an image showing the position of the sound source as viewed from immediately above the user, as shown in FIG. 7 (a). When the sound source is located immediately or obliquely above the user, this section generates an image showing the position of the sound source as viewed from obliquely above the user, as shown in FIG. 7 (b). As described above, the image having a form of display conforming to the direction of the sound source and traveling direction allows the user to achieve quick and intuitive grasping of the position of the sound source.

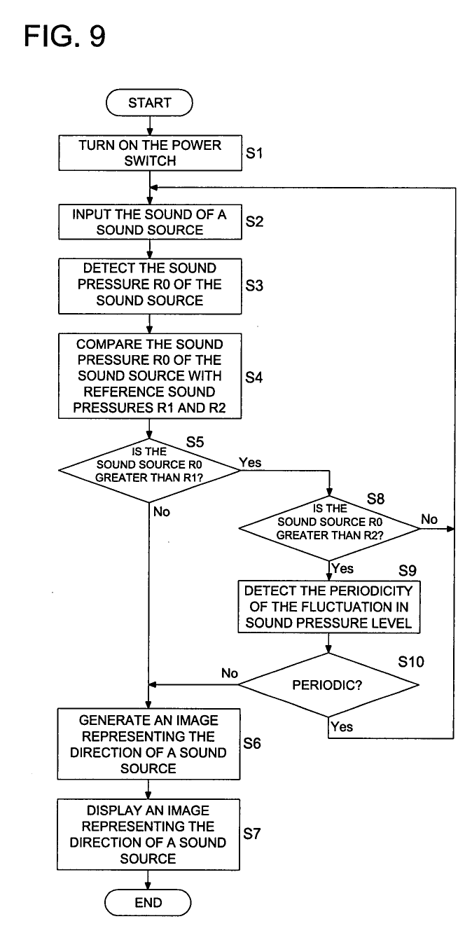

Referring to FIG. 9, the following describes the flow of the display control operation of the image showing the direction of the sound source to be performed by the HMD1. FIG. 9 is a flow chart representing the flow of the display control operation of the image showing the direction of the sound source to be performed by the HMD1. The flow of the display control operation of the image showing the traveling direction of the sound source is approximately the same as that of the image showing the direction of the sound source, and therefore, will not be described to avoid duplication.

In the first place, the power switch 830a is operated to supply power to the HMD1. When the HMD1 has operated (Step S1), the microphones 851a through 851e input sound from the sound source and generate an audio signal (Step S2: Audio signal generation step). Based on the audio signal generated by the microphones 851a through 851e, the sound source property detecting section 805 detects the sound pressure R0 of the sound coming from the sound source (Step S3).

The image controller 807 makes a comparison between the sound pressure R0 detected by the sound source property detecting section 805 and the preset reference sound pressures R1 and R2 (Step S4). In this case, R1 and R2 meet the requirement of R1>R2.

If the sound pressure R0 is greater than the reference sound pressure R1 (Step S5: Yes), the image generation section 802 under control of the image controller 807 generates an image representing the direction of the sound source (Step S6: image generating step), based on the direction of the sound source detected by the sound source detection section 803 (sound source detecting step). Then the section 802 outputs the generated image to the display unit 6, where the image is displayed (Step S7: image generating step).

In the meantime, in Step S5, if the sound pressure R0 is smaller than the reference sound pressure R1 (Step S5: No), and is greater than the reference sound pressure R2 (Step S8: Yes), the sound source property detecting section 805 senses the periodicity of the level fluctuation of the sound pressure R0 (Step S9) according to the audio signal generated by the microphones 851a through 851e. To be more specific, a check is made to see if the level of the sound pressure R0 fluctuates at a certain period or not.

If the level fluctuation of the sound pressure R0 is not periodic (Step S10: No), the image generation section 802 under the control of the image controller 807, as in the cases of Step S6 and Step S7, generates an image showing the direction of the sound source, based on the direction of the sound source detected by the sound source detection section 803. The section 802 then outputs the generated image on the display unit 6, where the image is displayed.

As described above, in the HMD1 of the present invention, only when the sound pressure R0 of the sound source is greater than the reference sound pressure R1, or the level fluctuation of the sound pressure R0 is not periodic, the image representing the direction of the sound source and the traveling direction (hereinafter collectively referred also to as “sound source image”) is displayed. To be more specific, when the sound pressure R0 is relatively small or the level fluctuation of the sound pressure R0 is periodic, noise is generated on a stationary basis in many cases, and the user is less exposed to danger. Accordingly, the sound source image is not displayed. In the meantime, if the sound pressure R0 is very great, or the level fluctuation of the sound pressure R0 is not periodic with the sound pressure occurring as a one-time event, then the user may be exposed to danger. In this case, a sound source image is displayed to notify the user of a possible danger.

The sound source image can be displayed in response to the sound pressure change rate and frequency change rate of the sound source detected by the sound source property detecting section 805. For example, when the level of noise has been increased suddenly during the walk or an abnormal noise of different nature has been detected, a sound source image is displayed to caution the user.

It is also possible to make the following arrangement: When the sound source property detecting section 805 has detected a specific frequency, the sound source image is displayed. For example, a sound source image is displayed when a sound which requires calling of the user's attention has been detected, wherein such a sound includes a chime notifying the arrival or departure of a train or an alarm sound at a railway crossing.

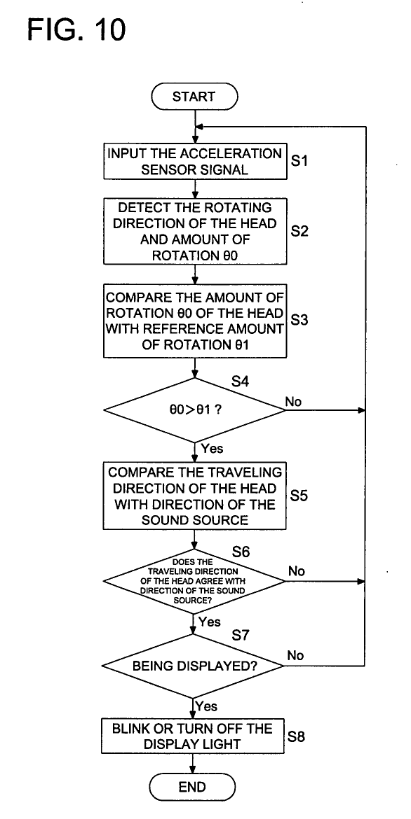

Referring to FIG. 10, the following describes the flow of the display control operation of the sound source image due to a change in head position to be performed by the HMD1. FIG. 10 is a flowchart representing the flow of the display control operation of the sound source image due to a change in head position to be performed by the HMD1.

In the first place, the acceleration sensor 855 detects the acceleration signal of the swing when the HMD1 is rotated by the movement of the user's head (Step S1). Based on the acceleration signal detected by the acceleration sensor 855, the head position change detecting section 806 detects the rotating direction of the head and amount of rotation θ0 (Step S2).

The image controller 807 makes a comparison between the amount of rotation θ0 of the head detected by the head position change detecting section 806 and the preset reference amount of rotation θ1 (Step S3). If the amount of rotation θ0 of the head is greater than the reference amount of rotation θ1 (Step S4: Yes), the image controller 807 makes a comparison between the rotating direction of the head detected by the head position change detecting section 806 and the direction of the sound source detected by the sound source detection section 805 (Step S5).

If there is agreement between the rotating direction of the head and the direction of the sound source (Step S6: Yes), the image controller 807 checks to see if the sound source image is being displayed or not. If the sound source image is being displayed (Step S7: Yes), the light of the symbol representing the sound source in the sound source image is blinked or is turned off.

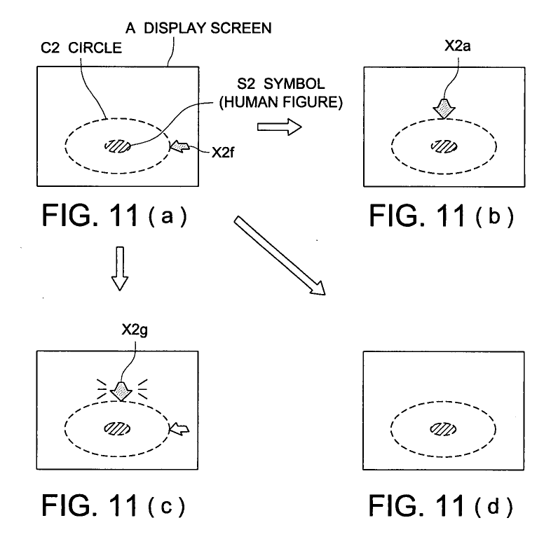

Referring to FIGS. 11 (a) through 11 (d), the following describes an example of displaying the sound source image resulting from a change in head position. The form of displaying the sound source image shown in FIG. 11 (a) through FIG. 11 (d) is the same as that of the aforementioned FIG. 7 (b). Accordingly, the description of the symbols and others will be omitted.

As shown in FIG. 11 (a), when the sound source (symbol x2f) positioned on the right of the user (symbol S2) has moved to the front of the user, the symbol x2a representing the sound source is lighted for display as usual, as shown in FIG. 11 (b).

When the user turns his head with respect to the sound source (symbol x2f) originally placed on the right of the user (symbol S2) as shown in FIG. 11 (a), and faces this sound source, then the light of the symbol x2g representing the sound source is blinked or turned off as shown in FIG. 11 (c) or FIG. 11 (d).

As described above, the symbol for the sound source is displayed in a different form depending on whether the relative movement of the sound source with respect to the user is caused by the movement of the sound source or turning of the user's head. This arrangement ensures more correct grasping of the state of the sound source.

As described above, in the image display apparatus of the present invention mounted on the head or face of a user wherein the user can see through the apparatus to observe the external world, the image generation section 802 generates an image representing the direction of the sound source, based on the direction of the sound source detected by the sound source detection section 803, and outputs it to the display unit 6. Thus, even when used by an aurally handicapped person or in an environment where sounds are difficult to hear, if the user looks at the direction of the sound source displayed on the display unit 6, a clear observation of the sound source is provided by the natural image (see-through image) illuminated by the external light that can be observed through the display unit 6, and easy identification of the sound source is ensured by this arrangement. Further, based on the traveling direction of the sound source detected by the sound source detection section 803, the image generation section 802 generates an image denoting the traveling direction of the sound source, and outputs it to the display unit 6. Thus, even when used by an aurally handicapped person or in an environment where sounds are difficult to hear, if the user checks the traveling direction of the sound source displayed on the display unit 6, the user is immediately notified as to whether the sound source is moving away or toward him. This arrangement provides easy identification of whether the sound affects the user or not. Thus, the user is alerted to a possible danger.

In the image display apparatus of the present invention mounted on the head or face of a user wherein the user can see through the apparatus to observe the external world, the information on the direction of the sound source is displayed as an image. Thus, the content sound being enjoyed can be fully appreciated without being interrupted.

In a method for displaying image in an image display apparatus mounted on the head or face of a user wherein the user can see through the apparatus to observe the external world, the image generating step generates an image representing the direction of the sound source, based on the direction of the sound source detected by the sound source detection section, and outputs it to the display unit. Thus, even when used by an aurally handicapped person or in an environment where sounds are difficult to hear, if the user looks at the direction of the sound source displayed on the display unit, a clear observation of the sound source is provided by the natural image (see-through image) using the external light that can be observed through the display unit, and easy identification of the sound source is ensured by this arrangement. Further, the information on the direction of the sound source is displayed as an image. Thus, the content sound being enjoyed can be fully appreciated without being interrupted.

The embodiments of the present invention have been described with reference to embodiments. It is to be expressly understood, however, that the present invention is not restricted thereto. It goes without saying that the present invention can be embodied in a great number of variations with appropriate modification or additions.

For example, it is also possible to make the following arrangement: If the sound pressure is reduced below the preset reference sound pressure during the display the sound source image, the display can be turned off after the lapse of a predetermined period of time. Alternatively, the brightness of the display can be reduced. This procedure visually informs the user that the possible danger of the sound source has been reduced.

What is claimed is:

1. An image display apparatus which is for being attached to a head or a face, and through which a user is able to see an outside world, the apparatus comprising:
a display section which is see-through and displays an image;
an audio input section for inputting a sound generated by a sound source in the outside world and generating an audio signal;
a sound source detection section for detecting a relative direction of the sound source with respect to the image display apparatus based on the audio signal generated by the audio input section; and
an image generation section for generating an image to indicate a direction of the sound source and displaying the image on the display section.

2. The image display apparatus of claim 1, wherein the sound source detection section detects a relative traveling direction of the sound source with respect to the image display apparatus based on the audio signal generated by the audio input section, and the image generation section generates an image to indicate the traveling direction based on the traveling direction detected by the sound source detection section.

3. The image display apparatus of claim 2, comprising:
an image selection section for selecting an image to be generated by the image generation section,
wherein the image generation section generates an image to indicate the direction of the sound source and an image to indicate the traveling direction of the sound source or each of the image to indicate the direction and the image to indicate the traveling direction.

4. The image display apparatus of claim 1, wherein the audio input section comprising:
two microphones for collecting the sound generated by the sound source at different positions of the image display apparatus, each of the microphones is arranged facing outwardly centering around the head of the user to be directed different directions.

5. The image display apparatus of claim 1, comprising:
a sound recognition section for recognizing the sound generated by the sound source and converting the sound into linguistic information based on the audio signal generated by the audio input section,
wherein the image generation section generates an image according to the linguistic information converted by the sound recognition section.

6. The image display apparatus of claim 1, wherein the image generation section displays information about the sound source in whole surrounding area of the user as a sound source image indicating a direction of a sound source.

7. The image display apparatus of claim 6, wherein the image generation section displays the sound source image with the user observed from immediately above the user.

8. The image display apparatus of claim 6, wherein the image generation section displays the sound source image with the user observed from obliquely above the user.

9. The image display apparatus of claim 6, wherein the image generation section displays the sound source image with a sound source in a horizontal direction and a sound source in a non-horizontal direction distinguished therebetween.

10. The image display apparatus of claim 6, wherein the image generation section displays, as the sound source image, a situation of continuously moving of the sound source.

11. The image display apparatus of claim 6, wherein the image generation section changes the sound source image into an expression which is easy to visually recognize as the sound source reaches the user.

12. The image display apparatus of claim 1, wherein the image generation section generates the sound source image based on the detected sound source which meets a predetermined standard.

13. The image display apparatus of claim 12, wherein the predetermined standard is that a sound pressure of the sound source is not less than a predetermined value.

14. The image display apparatus of claim 12, wherein the predetermined standard is that the sound source includes a predetermined frequency range.

15. The image display apparatus of claim 12, wherein the predetermined standard is that a sound pressure change rate of the sound source is not less than a predetermined value or the sound source includes a frequency change rate not less than a predetermined value.

16. The image display apparatus of claim 1, comprising:
a movement detection section for detecting a movement of the display section,
wherein when the image generation section detects the movement of the display section, the image generation section changes the display of the sound source image in conjunction with a direction of the movement.

17. The image display apparatus of claim 16, wherein when the image generation section judges that the display section turns to the direction of the sound source displayed on the display section, the image generation section stops displaying the image to indicate the direction of the sound source.

18. A method for displaying an image on an image display apparatus which is for being attached on a head or a face, and through which a user is able to see an outside world, the method comprising the steps of:
displaying the image on a see-through display section;
inputting a sound generated by a sound source in the outside world, and generating an audio signal;
detecting a relative direction of the sound source with respect to the image display apparatus based on the audio signal;
generating an image to indicate the direction of the sound source based on the detected direction of the sound source; and
displaying the image on the display section.

19. An image display apparatus, comprising:
a display section for superimposing and displaying an image in a view field of a user of the image display apparatus;
a detection section for detecting location information of an sound source in a surrounding area of the user; and
a display control section for generating an image to indicate a location of the detected sound source and displaying the image on the display section.
